(19) United States
(12) Patent Application Publication
(10) Pub. No.: US 2018/0214893 A1
(43) Pub. Date: Aug. 2, 2018

(54) SEPARATOR DRUM AND SEPARATOR

(71) Applicant: GEA MECHANICAL EQUIPMENT GMBH, Oelde (DE)

(72) Inventors: Angelika VOLTMANN, Rheda-Wiedenbrück (DE); Jens UEDING, Beckum (DE)

(21) Appl. No.: 15/745,821

(22) PCT Filed: Jul. 6, 2016
(86) PCT No.: PCT/EP2016/065919

§ 371 Date: Jan. 18, 2018

(30) Foreign Application Priority Data
Jul. 30, 2015 (DE) 20 2015 103 984.0

(51) Int. Cl. B04B 11/06; B04B 11/04; B04B 1/08

(52) U.S. Cl. CPC B04B 11/06; B04B 1/08; B04B 11/04

(57) ABSTRACT

A separator drum for a separator for centrifugally separating a suspension into at least one liquid phase and one solid phase or into two liquid phases and preferably one solid phase. The separator drum includes a vertical axis of rotation, and a drum lower part and a drum upper part, into which a product to be processed can be fed, into a drum interior, via a feed tube and a distributor. The distributor has a distributor shaft, a conical distributor foot, distributor channels, formed in the distributor foot, into the drum interior, at least one liquid outlet, and at least one solid outlet. The distributor foot has a lower distributor foot base and an upper distributor foot cover plate, which can be mounted on the distributor separately from the conical distributor foot base.

### BACKGROUND AND SUMMARY OF THE INVENTION

Exemplary embodiments of the invention relate to a separator drum and a separator.

Known separators and separator drums are disclosed in German patent document DE 10 2004 038 613 A1. In the known separator, solid phases are continuously discharged through nozzles or discontinuously by piston slides on a relatively large radius of the centrifugal and separator drum. At continuous discharging, a relatively large energy loss is connected to discharging. If the solid phase is suitable with respect of its flowability, it may therefore be useful to not continuously discharge the phases through nozzles but via solid discharge openings, which are provided upstream with piston slides that are opened discontinuously, so that energy-efficient operation is then achieved.

In order to achieve a defined opening and closing movement, separator drums have proved successful with piston slides that are associated with a hydraulic control system. The control system often includes a closing chamber, from which control water quantities are drained for a quick opening operation of the piston slide and which are filled with control water to close the solid discharge openings again. However, the opening gap, which is obtained, in particular in case of partial emptying, is generally smaller than the maximum opening gap. In the case of total emptying, the opening gap should preferably be fully utilized, so that also adhering solid material can be ejected. However, this can only be achieved if the gap is large enough and remains open for a sufficient period of time. This can be achieved by an additional opening chamber (also called forced-opening chamber) in the separator drum, which ensures that the piston slide securely opens well and reaches its end position. For this purpose, it is known to form the forced-opening chamber between the upper side of the piston slide and the underside of the distributor foot. However, for the realization of inlet/distribution channels in the separator drum the distributor foot must be machined in a relatively costly manner. If insofar different distributor variants can be realized, e.g., to design the distribution channels in the distributor foot in different ways or if openings in riser channels in a plate pack are to be arranged at different radii, it is furthermore difficult to provide many different distribution variants.

Exemplary embodiments of the invention are directed to simplifying the structure of the generic separator drum by optimizing the structure of its distributor and, according to a preferred embodiment, also to remedy the problem described above.

According to an embodiment, a separator drum for a separator for the centrifugal separation of a suspension into at least one liquid phase and a solid phase or into two liquid phases and preferably one solid phase, has at least the following features: a vertical axis of rotation; a drum lower part and a drum upper part, wherein a product to be processed can be guided through a feed pipe and a distributor into a drum interior, wherein the distributor has a distributor shaft, a conical distributor foot and distributor channels into the drum interior which are formed in the distributor foot, wherein further at least one or more liquid outlet/outlets and preferably at least one solid outlet are provided, and wherein the distributor foot consists of at least two assembled components. The structural division of the distributor foot makes it easier to realize different geometries and arrangements of distribution channels in the distributor foot.

For this purpose, it is further advantageous if the distributor foot has a lower distributor foot base and an upper distributor foot cover plate, which can be mounted as a separate part on the distributor shaft, because this allows the distributor channels extending between these two parts to be realized in a simple manner by providing corresponding geometric contours on the underside of the distributor foot cover plate and on the upper side of the distributor foot base, wherein these contours delimit the distribution channels in the mounted state. It is thus possible to realize different distributor variants by providing different variants of conical distributor foot cover plates with a uniform distributor foot base, in particular also when a forced-opening chamber is to be provided.

The multi-part distributor foot is in particular advantageously, but not exclusively, suitable for separator drums in which the solid discharge has solid discharge openings in the separator drum, which can be opened and closed with a displaceably guided piston slide in the separator drum, wherein further an opening chamber is formed between the upper side of the piston slide and the underside of the distributor foot base, which opening chamber can be acted upon with a fluid for moving the piston slide, because the very formation of such an opening chamber often makes it difficult to form suitable distribution channels in the distributor foot.

It is expedient if the distributor foot base and the distributor foot cover plate are conical.

It is also advantageous according to a further development during mounting if the distributor foot cover plate can be placed vertically from above onto the vertically oriented (relative to operating position during rotations) distribution shaft and if the distributor foot cover plate is arranged in the mounted state below the plate pack.

The distributor foot cover plates can be simply fixed to the distributor shaft because the distributor foot cover plate has on its inner circumference a gradation, which rests in the mounted state on a corresponding gradation of the distributor shaft. In this case, it is advantageous for sealing the corresponding region/gap, if at least one seal, in particular a sealing ring, is arranged between the distributor foot cover plate and the distributor shaft.

It is also advantageous and simple if the distribution channels for supplying a product to be processed into the drum interior are formed between the distributor foot base and the distributor foot cover plate.

The invention makes it possible that the distribution channels are separated by ribs in the circumferential direction.

It is advantageous if the distributor channels open radially into bores in the distributor shaft and/or if the distributor channels, on the other hand, extend radially up to the outer radius of the distributor foot, so that an incoming product can flow radially advantageously into the drum interior.

Alternatively or optionally, the distributor foot cover plate can comprise at least one or more axial opening(s), which are preferably aligned upwards with the riser channels and open at the bottom into the distribution channels. It is a particular advantage of the invention that by exchanging only the distributor foot cover plate, different distribution variants, with openings below the riser channels at different radii for example, can be realized. For this purpose, ribs are preferably provided only on the underside of the distributor foot cover plate and/or on the upper side of the distributor foot base.

Finally, the invention also provides an advantageous separator with a separator drum according to one or more of the claims directed thereon.

### BRIEF DESCRIPTION OF THE DRAWING FIGURES

The invention will be described below in closer detail with reference to embodiments shown in the drawings, wherein:

FIG. 1 shows a section through a separator drum shown in simplified form with a hood, on which also an inlet region for the separator drum and a part of a drive spindle are shown; and

FIG. 2 shows an enlarged section from FIG. 1.

### DETAILED DESCRIPTION

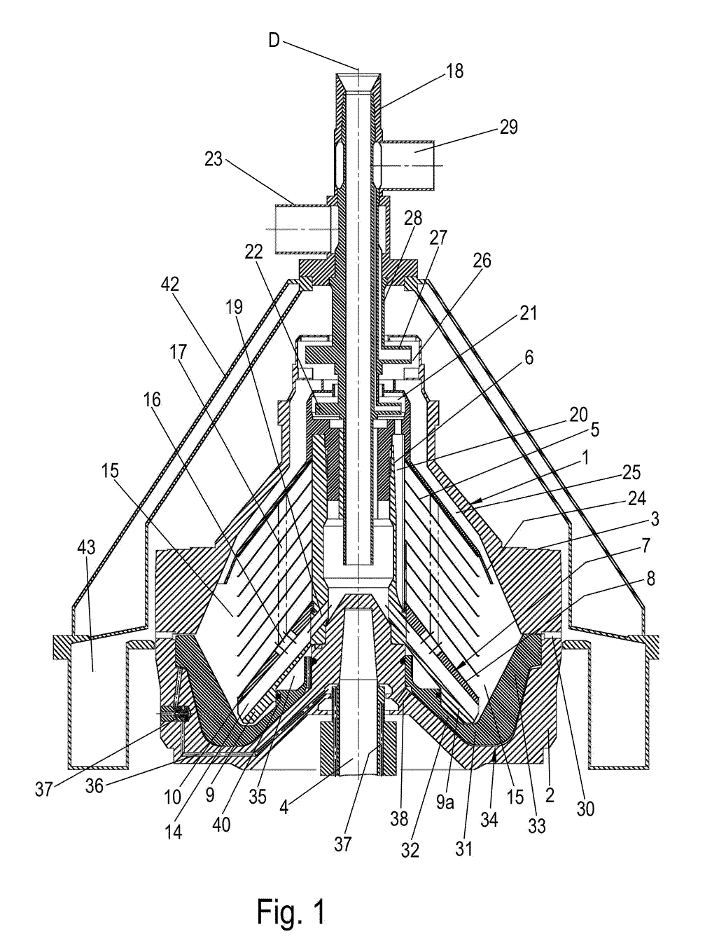

FIG. 1 shows a partially simplified representation of a separator drum 1, which is also called a centrifugal drum, rotatable about a vertical axis of rotation D of a separator which can be operated continuously.

The separator drum 1 has a drum lower part 2 and a drum upper part 3. These two drum parts are connected to each other in a manner not shown here in detail. For example, they can be screwed together or held together by a locking ring. Although the drum upper part and drum lower part are drawn in FIG. 1 in a hatching throughout, they concern separate parts in practice. Connections such as screw connections between these parts, in particular with a locking ring, are known per se to a person skilled in the art and do not require any further explanation and discussion here.

The separator drum 1 is further formed in a preferred embodiment in a double conical manner on the inside and outside. The separator drum 1 is mounted in a rotationally fixed manner on a drive spindle 4, so that it is co-rotated during operation by the rotating drive spindle 4. The drive spindle 4 is driven in a manner not shown here by a drive motor directly in extension of the drive spindle or via a belt drive with a drive belt or the like.

In the separator drum, a plate pack 5 consisting of a plurality of plates is arranged concentrically to the vertical axis of rotation D. The plates of the plate pack 5 have a conical shape and are stacked axially one above the other and are preferably kept spaced apart by means of spacers (tabs and the like) that are not shown here.

In the separator drum 1, a distributor 7 with a distributor shaft 6 and a distributor foot 8 is also arranged. The plate pack 5 is held on the distributor shaft 6, with tubular geometry, of the distributor 7. The distributor shaft 6 may be provided with radially outwards projecting webs (not shown here) on its outer circumference, wherein the plates of the plate pack 5 are supported on these webs.

At its lower end, the distributor 7 has the preferably conical distributor foot 8, which widens conically starting from the lower region of the distributor shaft downwards and outwards.

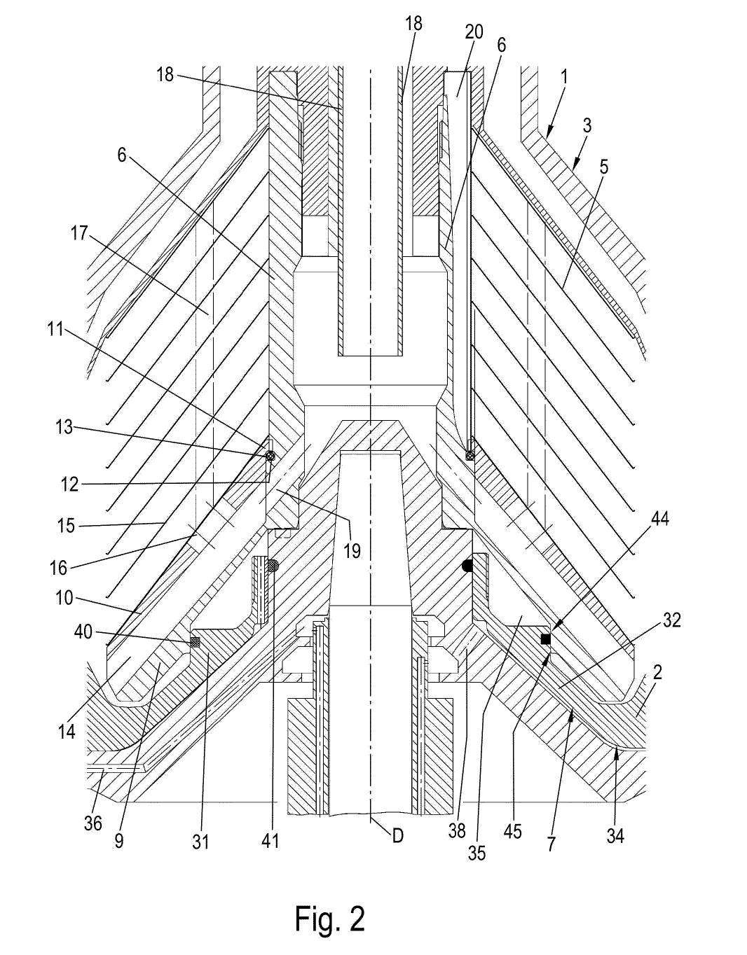

The conical distributor foot 8 has a lower, preferably conical, distributor foot base 9, which is attached to the lower end of the distributor shaft 6 or preferably, in order to avoid gaps, is integrally formed therewith. The conical distributor foot 8 also has a distributor foot cover plate 10 which is arranged vertically above the conical distributor foot base 9 and is axially spaced from the distributor foot base 9. The distributor foot cover plate 10 is placed on the distributor shaft 6. For this purpose, the distributor foot cover plate 10 can comprise a gradation 11 on its inner circumference, which is placed on a corresponding gradation 12 (FIG. 2) of the distributor shaft 6. In this case, the gradations are oriented such that the distributor foot cover plate 10 can be placed from the top onto the distribution shaft 6 during assembly, so that the distributor foot cover plate 10 rests vertically downwards on the gradation 12 of the distributor shaft 6.

Between the distributor foot cover plate 10 and the distributor shaft 6, a sealing ring 13 can be arranged in the region of the gradations 11 and 12 in order to seal the gap well between the distributor shaft 6 and the distributor foot cover plate 10.

Distribution channels 14 are formed between the conical distributor foot base 9 and the distributor foot cover plate 10. These distribution channels 14 extend conically in a radially outward manner. They lead into the drum interior 15. Vertically extending openings/holes 16 may further be formed in the distributor foot cover plate 10. These openings 16 are aligned vertically upward with riser channels 17 in the plate pack 5, which serve to feed the product into the drum interior 15.

A feed pipe 18 protrudes concentrically into the distributor shaft 6. In contrast to the distributor shaft 6, this feed pipe 18 preferably does not co-rotate with the separator drum 1 in the operation of the separator drum 1, but is designed as a stationary part. The feed pipe 18 serves to feed a product to be processed into the separator drum 1. In a preferred embodiment, it protrudes vertically from above into the separator drum 1. At its lower end, the feed pipe 18 opens into the distributor shaft 6, from which it is radially spaced. The product to be processed flowing through the feed pipe 18 enters from the feed pipe 18, which does not rotate in operation, vertically downwards into the interior of the rotating distributor shaft 6, where it flows in openings 19 at the lower end of the distributor shaft radially outward into the distribution channels 14 of the distributor foot. This type of product introduction into the drum is particularly gentle on the product and thus advantageous.

When entering the openings 19, the incoming product is accelerated due to the rotations of the separator drum 1 in the circumferential direction and brought to the operating speed. Then the product passes through the distribution channels 14, the openings 16 and the riser channels 17 in gaps between the plates of the plate pack 5, where the separation takes place in liquid phases of different density and/or a clarification of solids.

The separator drum 1 of FIG. 1 is formed by way of example as a “separator” and “clarifier”, i.e., a liquid consisting of two different liquid phases with different density and solids is separated into these liquid phases of different density and clarified from solids. In this case, the lighter fluid phase flows radially inward in the plate pack 5. It is conducted there into a discharge channel 20 axially upwards into a (first lower) paring chamber 21, in which a centripetal pump or paring disc 22, which is fastened to the feed pipe and does not operate in rotation, is arranged as a liquid discharge, which serves to conduct the discharged light liquid phase upward from the separator drum 1 to a discharge line 29 for the lighter liquid phase. However, the distributor 7 is also suitable for pure “separators” for separating a product into two phases “liquid/liquid” with two paring discs (or two other discharges) or for pure “clarifiers” with a solid discharge and only one paring disc (or another discharge). The liquid discharges and solid discharges can also be designed differently than shown in the drawing.

The heavy liquid phase flows from the plate pack 5 into a region radially outside of the plate pack 5 and flows there radially further outwards until it flows over the radial outer edge of a separator plate 24 which is arranged above the plate pack 5. The heavy liquid phase flows over the radially outer edge of the separator plate 24 upwards into channels 25 between the separator drum upper part 3 and the separator plate 24 and is conducted there into a second paring chamber 26. In the second paring chamber 26, a second paring disc 27 is arranged as a second liquid discharge. The second paring disc 27 serves to conduct the heavy liquid phase in the manner of a pump through a discharge channel 28 out of the separator drum 1 into the region of a discharge line 23, through which the heavy liquid phase can flow off.

For discharging a solid phase, which is collected in clarifying the product to be processed in the outer radial region of the drum interior 15, a solid discharge with solid discharge openings 30 at the largest circumference of the separator drum 1 is preferably used. These solid discharge openings 30 can be closed by means of a piston slide 31 (FIG. 1).

The piston slide 31 has a shape which widens vertically from the inside to the outside, wherein the first conical section 32 widens conically in a vertically downward and radially outward manner. This first conical section is adjoined by a second conical section 33, which is aligned in the opposite direction.

The piston slide 31 is hydraulically actuated. For this purpose, a closing chamber 34 is formed in this case at first between the drum lower part 2 and the piston slide 31. If it is supplied with fluid, preferably control water, the piston slide is moved vertically upwards, so that the piston slide 31 is closed. As a result of pressure drop in the closing chamber 34, the piston slide 31 can sink vertically downwards especially due to the pressure of the product acting axially from above in the drum interior 15.

This movement is assisted by the fact that a forced-opening chamber 35 (see also FIG. 2) is formed above the piston slide 31 between the piston slide 31 and the conical distributor foot base 9. This forced-opening chamber 35 can also be acted upon with fluid. Before the opening of the piston slide 31 it is filled with fluid. Thereafter, the pressure in the closing chamber 34 is released. Thus, an acceleration of the opening movement or a particularly suitable driving of the opening movement of the piston slide 31 can occur by the forced-opening chamber 35. This makes it possible to carry out the movement of the piston slide 31 from the closed position into the open position vertically downwards in a particularly defined manner in a predetermined time interval.

For pressurizing the closing and forced-opening chambers 34, 35 with fluid, feed channels are provided in the drum lower part 2. One of these feed channels is the feed channel 36. It opens into the closing chamber 34. In the feed channel 36, a valve 37 is arranged.

A second feed channel 38 extends through the drum lower part 2 into the forced-opening chamber 35, so that a fluid, in particular control water, can also be conducted into this chamber. In this case, the forced-opening chamber 35 is formed in the space between the lower conical distributor foot base 9 and the upper side of the piston slide 31. Inwards, it is bounded by the drum lower part 2.

During operation, fluid is injected on the spindle into the corresponding feed channels 36, 38 when opening or closing is to take place. This is known per se and will therefore not be described in detail here.

In order to provide an adequately defined volume for the forced-opening chamber 35, the piston slide 31 and the conical distributor foot base 9 can comprise recesses and correspondingly shaped cylindrical shaped regions 44, 45. Between the piston slide 31 and the conical distributor foot base 9 and between the piston slide 31 and the drum lower part 3 seals 40, 41 may further be arranged in order to seal the forced-opening chamber 35 in these areas/gaps.

It is necessary to mention as particularly advantageous in the construction of the distributor 7 with an integral component having the parts “distributor shaft” 6 and “distributor foot base” 9 and the other part “distributor foot cover plate” 10, which can be mounted thereon and which is not formed integrally with the rest of the distributor 7, that it is particularly easy to create a variety of distribution variants by this two-part design of the distributor 7.

This relates in particular to the shape of the distribution channels 14, which can be formed by corresponding contours, in particular ribs, at the top of the distributor foot base 9 and/or the underside of the distributor foot cover plate 10. The distribution channels 14 may extend radially into the drum interior and can optionally/alternatively also conduct the product to be processed through the vertically aligned openings 16 into the riser channels 17 of the plate pack 5.

The vertical openings/holes 16 in the distributor foot cover plate 10 can further easily be placed on different radii. Therefore, it is only necessary to vary the distributor foot cover plates 10 to create distributors 7 with openings 16 which open into riser channels 17 on different radii.

It should also be noted that the separator drum 1 is surrounded by a hood 42 (shown in a simplified manner). This hood 42 does not co-rotate in operation with the separator drum 1. It has a solid scavenger 43, into which the solids flow which flow out of the solid discharge openings 30 and in which they are collected and from which they can be discharged.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

Separator drum 1
Drum lower part 2
Drum upper part 3
Drive spindle 4
Plate pack 5
Distributor shaft 6
Distributor 7
Distributor foot 8
Distributor foot base 9
Distributor foot cover plate 10
Gradation 11
Gradation 12
Sealing ring 13
Distribution channel 14
Drum interior 15
Opening 16
Riser channel 17
Feed pipe 18
Opening 19
Discharge channel 20
Paring chamber 21
Paring disc 22
Discharge 23
Separator plate 24
Channel 25
Paring chamber 26
Paring disc 27
Discharge channel 28
Discharge 29
Solid discharge opening 30
Piston slide 31
Conical section 32
Conical section 33
Closing chamber 34
Forced-opening chamber 35
Feed channel 36
Valve 37
Feed channel 38
Seal 40, 41
Hood 42
Solid scavenger 43
Regions 44, 45
Axis of rotation D

1-15. (canceled)

16. A separator drum for a separator that centrifugal separates a suspension into at least one liquid phase and one solid phase or into two liquid phases and one solid phase, the separator drum comprising:
a vertical axis of rotation;
a drum lower part and a drum upper part into which a product to be processed can be guided through a feed pipe and a distributor into a drum interior, wherein the distributor has a distributor shaft, a conical distributor foot, and distribution channels into the drum interior which are formed in the conical distributor foot; and
at least one liquid discharge and at least one solid discharge,
wherein the conical distributor foot has a lower distributor foot base and an upper distributor foot cover plate which is mountable on the distributor separately from the distributor foot base.

17. The separator drum of claim 16, wherein the at least one solid discharge has solid discharge openings, which are openable and closable with a piston slide slidably guided in the separator drum.

18. The separator drum of claim 17, wherein between an upper side of the piston slide and an underside of the lower distributor foot base an opening chamber is formed, which can be pressurized with a fluid for moving the piston slide.

19. The separator drum of claim 16, wherein the lower distributor foot base and the upper distributor foot cover plate are conical.

20. The separator drum of claim 16, wherein the upper distributor foot cover plate is configured for placement on the distributor shaft.

21. The separator drum of claim 16, wherein the upper distributor foot cover plate is arranged in a mounted state directly below a plate pack.

22. The separator drum of claim 16, wherein the upper distributor foot cover plate has a gradation on its inner circumference, which rests in an assembled state on a corresponding gradation of the distributor shaft.

23. The separator drum of claim 16, wherein a sealing ring is arranged between the upper distributor foot cover plate and the distributor shaft.

24. The separator drum of claim 16, wherein a distribution channel or a plurality of distribution channels is formed between the lower distributor foot base and the upper distributor foot cover plate for supplying a product to be processed into the drum interior.

25. The separator drum of claim 24, wherein the distribution channels are separated from each other in a circumferential direction by one or more ribs.

26. The separator drum of claim 24, wherein the distribution channels open radially inwards into holes in the distributor shaft.

27. The separator drum of claim 24, wherein the distribution channels extend radially to an outer radius of the conical distributor foot, so that an incoming product flows radially outwards into the drum interior.

28. The separator drum of claim 16, wherein the upper distributor foot cover plate has axial openings/holes, so that an incoming product can flow vertically upwards into a plate pack.

29. The separator drum of claim 28, wherein the axial openings in the distributor foot cover plate are aligned with riser channels of the plate pack.

30. A separator that centrifugal separates a suspension into at least one liquid phase and one solid phase or into two liquid phases and one solid phase, the separator comprising:
a separator drum for a separator that centrifugal separates a suspension into at least one liquid phase and one solid phase or into two liquid phases and one solid phase, the separator drum comprising:
a vertical axis of rotation;
a drum lower part and a drum upper part into which a product to be processed can be guided through a feed pipe and a distributor into a drum interior, wherein the distributor has a distributor shaft, a conical distributor foot, and distribution channels into the drum interior which are formed in the conical distributor foot; and
at least one liquid discharge and at least one solid discharge,
wherein the conical distributor foot has a lower distributor foot base and an upper distributor foot cover plate which is mountable on the distributor separately from the distributor foot base.
